(19) United States
(12) Patent Application Publication
(10) Pub. No.: US 2026/0217051 A1
(43) Pub. Date: Jul. 30, 2026

(54) CLAMPING DEVICE FOR A PLURALITY OF SHEETS OF PAPER

(71) Applicant: BI-SILQUE, S.A., ESMORIZ (PT)

(72) Inventor: André VASCONCELOS, OVAR (PT)

(21) Appl. No.: 19/141,734

(22) PCT Filed: Jan. 8, 2024
(86) PCT No.: PCT/PT2024/050001

§ 371 Date: Jun. 20, 2025

(30) Foreign Application Priority Data
Feb. 9, 2023 (PT) 118505

(51) Int. Cl. B42F 1/00

(52) U.S. Cl. CPC B42F 1/00

(57) ABSTRACT

The invention is related to a clamping device (1) for a plurality of sheets of paper comprising an anterior delimiting surface (2); an upper delimiting surface (3); a rear delimiting surface (4); an inner delimiting surface (5); wherein a stacking area for the sheets of paper includes a first ridge (8); a second ridge (10), which is connected to a pivoting shaft (11); and a flexible elastic element (9).

In this way, the stacking area for sheets of paper is adapted to hold sheets of paper with differentiated amounts of paper or sheets of paper having differentiated thickness, considering the joint action between the first ridge (8), the flexible elastic element (9) and the pivoting shaft (11).

### TECHNICAL DOMAIN

The present invention is related to a clamping device for a plurality of sheets of paper adapted to be coupled to a support board for said plurality of sheets of paper, for example, a pad of paper.

### PRIOR ART

The state of the art presents several embodiments of paper clamping devices which can be coupled to support plates, for example frames, enabling the papers to be supported and allowing writing or exhibition of information on the papers supported on a board. FIG. 7 illustrates a first clamping device (14) according to the state of the art, which presents its own hooks to be inserted in orifices existing on the top margins of the sheets of paper.

FIG. 8 illustrates a second clamping device (15) according to the state of the art, which also presents its own hooks to be inserted in orifices existing on the top margins of the sheets of paper.

Said clamping devices of the state of the art are limited with respect to the practicality of fitting the pads of paper. The user must hold the clamping devices in one hand and simultaneously hold the pad of paper with the other hand, both when inserting the pad of paper in the clamping devices, as when removing same from the device.

### SOLUTION OF THE PROBLEM AND ADVANTAGEOUS EFFECTS OF THE INVENTION

The clamping device (1) for a plurality of sheets of paper solves the problems of the state of the art by incorporating a pivoting shaft (11) and a flexible elastic element (9) at the entrance of a stacking area for the sheets of paper, which act jointly to firmly and safely retain a plurality of sheets of paper, as will be described in detail.

The clamping device (1) for a plurality of sheets of paper presents several advantages in relation to the devices of the state of the art, for example, the ability to retain a plurality of sheets of paper more firmly, for example a pad of papers, independent of the thickness thereof and the eventual removal of pages from the pad.

### BRIEF DESCRIPTION OF THE FIGURES

With the purpose of providing an understanding of the principles according to the embodiments of the present invention, reference will be made to the embodiments illustrated in the figures and to the terminology used to describe them. In any case, it must be understood that there is no intention of limiting the scope of the present invention to the contents of the figures. Any subsequent alterations or modifications of the inventive characteristics illustrated herein, as well as any additional applications of the principles and embodiments of the invention illustrated, which would normally occur to a person skilled in the art in possession of this specification, are considered as being within the scope of the invention claimed.

FIG. 1—illustrates a first side view of the clamping device (1) according to the invention;

FIG. 2—illustrates a second view of the clamping device (1) according to the invention with emphasis on a trough (6) for connecting with an upper edge of a support board of a plurality of sheets of paper and a flexible, elastic element (9);

FIG. 3—illustrates a third view of the clamping device (1) according to the invention with emphasis on a shaft (11) which contacts a first ridge (8);

FIG. 4—illustrates a fourth view of the clamping device (1) according to the invention with emphasis on a plurality of protuberances (7) and an entrance (13) to the stacking area of the sheets of paper;

FIG. 5—illustrates a fifth view of the clamping device (1) according to the invention with emphasis on an orifice (12) wherein there is inserted a pivoting shaft;

FIG. 6—illustrates a pivoting shaft (11);

FIG. 7—illustrates a first clamping device (14) according to the state of the art;

FIG. 8—illustrates a second clamping device (15) according to the state of the art.

### DESCRIPTION OF THE EMBODIMENTS

The present invention is related to a clamping device (1) for a plurality of sheets of paper comprising:

an anterior delimiting surface (2); and

an upper delimiting surface (3); and

a rear delimiting surface (4); and

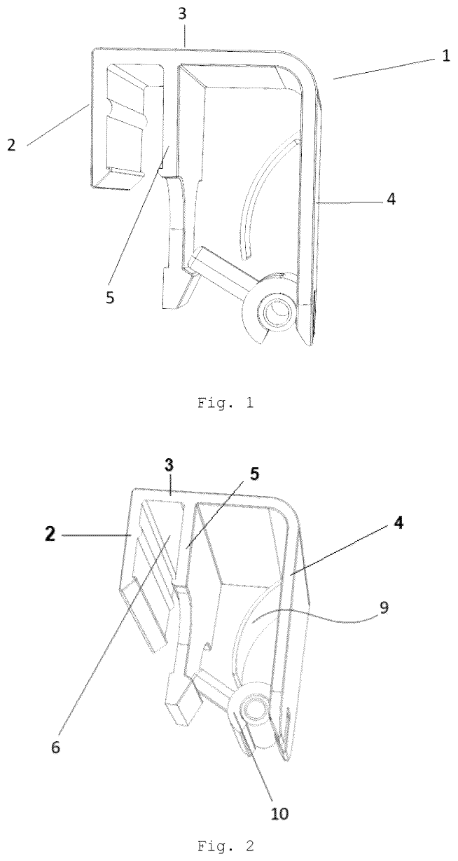

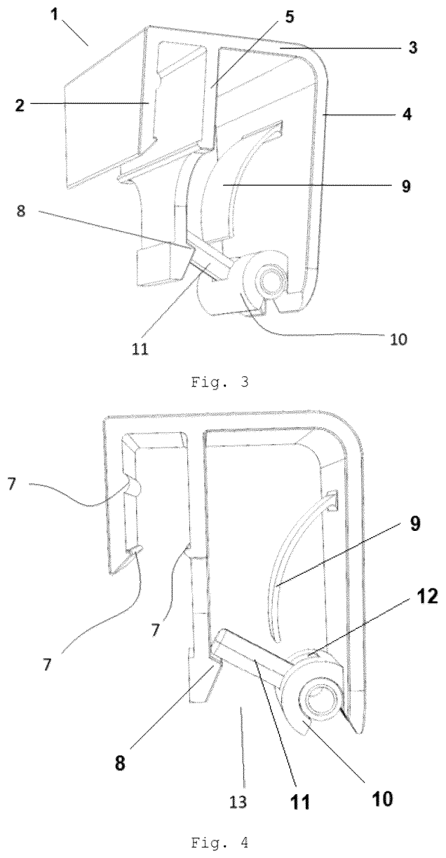

an inner delimiting surface (5); and

wherein the anterior delimiting surface (2), the rear delimiting surface (4) and the inner delimiting surface (5) are perpendicularly arranged relative to the upper delimiting surface (3), as illustrated in FIG. 1; and

wherein the anterior delimiting surface (2), the inner delimiting surface (5) and an anterior portion of the upper delimiting surface (3) delimit a trough (6), which is configured for connecting with an upper edge of a support board of a plurality of sheets of paper, as illustrated in FIG. 2; and

wherein the rear delimiting surface (4), the inner delimiting surface (5) and a rear portion of the upper delimiting surface (3) delimit a stacking area of the sheets of paper; and

wherein the inner delimiting surface (5) has a first ridge (8), which is arranged on a lower portion of said inner delimiting surface (5) and is projected towards the interior of the stacking area of the sheets of paper, as illustrated in FIG. 3; and

wherein the rear delimiting surface (4) includes a flexible elastic element (9) and a second ridge (10), which are arranged on an inner face of said rear delimiting surface (4) and are projected towards the interior of the stacking area of the sheets of paper, wherein said flexible elastic element (9) is arranged above said second ridge (10), as illustrated in FIG. 2; and

wherein the second ridge (10) includes an orifice (12), wherein there is fitted a shaft (11), wherein said shaft (11) presents a pivoting movement relative to the transverse axis of the second ridge (10), whereby said pivoting movement has an amplitude which is arranged within the stacking area of the sheets of paper and is limited by the contact of the shaft (11) with the flexible elastic element (9), as illustrated in FIG. 4.

In the preferred embodiments of the clamping device (1), the longitudinal length of the inner delimiting surface (5) is greater than the longitudinal length of the anterior delimiting surface (2) and wherein the first ridge (8) and the second ridge (10) are arranged on a same plane parallel to the plane of the upper delimiting surface (3). Even more preferably, the longitudinal length of the inner delimiting surface (5) is approximately the same length of the rear delimiting surface (4).

In the particularly preferred embodiments of the clamping device (1), at least one surface selected from the group consisting of the anterior delimiting surface (2) and the inner delimiting surface (5) includes at least one transversely arranged protuberance (7). As illustrated in FIG. 4, both the anterior delimiting surface (2) and the inner delimiting surface (5) can include at least one protuberance (7). The protuberances (7) are adapted to grant a safer and firmer fitting with an upper edge of a support board of a plurality of sheets of paper.

In the other particularly preferred embodiments of the clamping device (1), the transverse length of a lower portion of the inner delimiting surface is smaller than the transverse length of an upper portion of the inner delimiting surface (5), as illustrated in FIG. 3. Even more preferably, the first ridge (8) is arranged on a terminal portion of the lower portion of the inner delimiting surface (5). This configuration contributes to a flexibility of the inner delimiting surface (5) in the sense of accommodating sheets of paper with differentiated amounts of paper or sheets of paper with differentiated thicknesses in the stacking area of the sheets of paper.

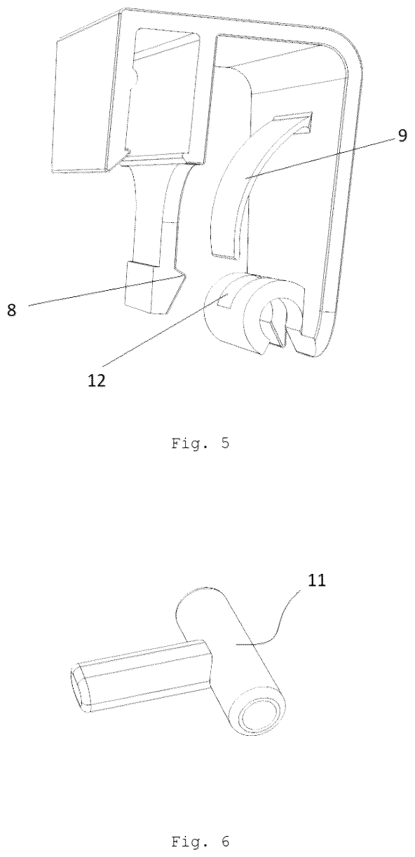

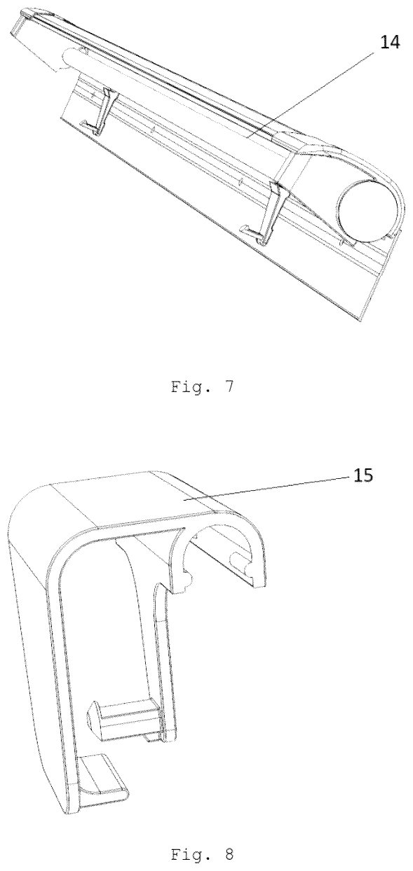

In the other particularly preferred embodiments of the clamping device (1), the flexible elastic element (9) is selected from the group consisting of a spring and a flap with a concave face projected toward the interior of the stacking area of the sheets of paper, wherein the base of the flap is connected to an upper portion of the rear delimiting surface (4) and the flexible terminal portion of the flap is arranged on a lower portion of the stacking area of the sheets of paper. Even more preferably, the flexible elastic element (9) is a flap having a concave face projected toward the interior of the stacking area of the sheets of paper, as illustrated in FIGS. 4 and 5. The flexible elastic element (9) also contributes to the stacking of the sheets of paper with differentiated amounts of paper or sheets of paper with differentiated thicknesses in the stacking area of the sheets of paper.

The flexible elastic element (9) is arranged above the second ridge (10), whereby both are arranged on the inner face of the rear delimiting surface (4), whereby the second ridge (10) includes an orifice (12), wherein there is fitted a shaft (11), wherein said shaft (11) presents a pivoting movement relative to the transverse axis of the second ridge (10), whereby said pivoting movement has an amplitude which is arranged within the stacking area of the sheets of paper and is limited by contact of the shaft (11) with the first ridge (8) and by the contact of the shaft (11) with the flexible elastic element (9).

In this way, the stacking area for the sheets of paper is adapted to hold sheets of paper with differentiated amounts of paper or sheets of paper having differentiated thickness, considering the joint action between the first ridge (8), the pivoting shaft (11) and the flexible elastic element (9).

Preferably, the plurality of sheets of paper constitutes a pad of paper with perforations on the upper margins. In order to illustrate the use of the invention, we shall use an example of a pad of paper with perforations on the upper margin thereof. The pad of paper is introduced in the stacking area of the sheets of paper by means of an entrance in the stacking area of the sheets of paper (13), passing through the space between the first ridge (8) and the second ridge (10). As the pad of paper is introduced in the stacking area of the sheets of paper, this elevates the shaft (11), which presses and compresses elastically the flexible elastic element (9) until the pad of paper is firmly stacked in the stacking area of the sheets of paper by means of the support provided by the inner face of the inner delimiting surface (5), by force of the reaction to the compression exerted by the flexible elastic element (9) and by the insertion of a terminal portion of the shaft (11) in a perforation on the upper margin of the pad of paper.

In a situation wherein the clamping device (1) is not stacking a pad or paper, the flexible elastic element (9) reacquires its initial position and pushes the shaft (11), until it rests over the first ridge (8).

The clamping device (1) is connected with an upper edge of a support board of a plurality of sheets of paper by means of fitting the trough (6) in said edge. The support board of a plurality of sheets of paper comprises a rigid surface, such as for example a board configured for writing, namely a white board or blackboard. Alternatively, the support board of a plurality of sheets of paper comprises a rigid support surface for the sheets of paper, wherein the rigid surface can be selected from the group consisting of a polymer material, for example a plastic; a metal; a metal alloy; wood; a wood derived composite; a wood chipboard; cork or any other material which grants rigid characteristics to the support board.

In this way, by means of the clamping device (1), a user can stack a pad or paper in the stacking area of sheets of paper after fitting the clamping device (1) to a support board of a plurality of sheets of paper. Next, the user can write on the sheets of paper, turn the paper backwards on the support board of a plurality of sheets of paper and/or remove one or more sheets of paper, whereby in any of the circumstances, the plurality of sheets of paper is firmly stacked in the stacking area of sheets of paper by means of the joint action of the pivoting shaft (11), by the flexible elastic element (9) and by the inner face of the inner delimiting surface (5).

In the particularly preferred embodiments of the clamping device (1), the second ridge (10) presents a semi-cylindrical configuration, which is transversely arranged relative to the inner face of the rear delimiting surface (4) and on a lower portion of said rear delimiting surface (4), as illustrated in FIG. 4. In this preferred configuration, an upper portion of the semi-cylinder includes an orifice (12), as illustrated in FIG. 5. The pivoting shaft (11) is inserted and fitted in the orifice (12), as illustrated in FIG. 4. Preferably, the shaft (11) includes a support base orthogonally arranged relative to the shaft (11), wherein said support base is fitted under the second ridge (10) and the shaft (11) pierces the orifice (12) of the second ridge (10).

In the particular embodiments of the shaft (11), as illustrated in FIG. 6, the support base of the shaft (11) has a cylindrical configuration. The cylindrical support base is fitted under a second ridge (10) presenting a semi-cylindrical hollow configuration while the shaft (11) pierces the orifice (12) of the second ridge (10), as illustrated in FIG. 4.

The several components of the clamping device (1) can be prepared from diverse materials, such as thermoplastic and thermoset polymers, for example, polyethylene, polypropylene, polycarbonate, polyamide, polystyrene and copolymers thereof, apart from other copolymers, such as Acrylonitrile butadiene styrene (ABS). Alternatively, the several components of the clamping device (1) can be prepared from metals and metal alloys.

The upper delimiting surface (3) does not require a substantially flat configuration, namely at the vertices between the upper delimiting surface (3) and the anterior delimiting surface (2), the rear delimiting surface (4) and the lower delimiting surface (5), whereby said vertices can have an arched configuration.

As employed in this description, the expressions “upper delimiting surface (3)”, “anterior delimiting surface (2)”, “rear delimiting surface (4)”, and inner delimiting surface (5)”, refer, respectively, to the external part of an upper body, an anterior body, a rear body and an inner body, wherein each of said bodies has an inner face and an outer face.

Preferably, the anterior body, the upper body, the rear body and the inner body include a structural element selected from the group consisting of a board, a frame and a frame having at least one framework internally connected to the frame. In the embodiment of the rear body which comprises a board, the base of the flexible elastic element (9) and the base of the second ridge (10) are connected to the inner face of said board, which includes the “rear delimiting surface (4)”. In the embodiment of the inner body having a board, the base of the first ridge (8) is connected to the inner face of said board, which includes the “inner delimiting surface (5)”. In the embodiment of the rear body which has a frame with at least one framework internally connected to the frame, the base of the flexible elastic element (9) and the base of the second ridge (10) are connected to a framework, which is included in the “rear delimiting surface (4)”. In the embodiment of the rear body which has a frame with at least one framework internally connected to the frame, the base of the first ridge (8) is connected to a framework, which is included in the “inner delimiting surface (5)”.

As employed in this description, the expressions “longitudinal” and “longitudinally” refer to the direction of any anterior delimiting surface (2), the rear delimiting surface (4) and the inner delimiting surface (5), wherein the direction is perpendicular to the reference plane of the upper delimiting surface (3). On the other hand the expressions “transverse” and “transversely” refer to the direction of any anterior delimiting surface (2), the rear delimiting surface (4) and the inner delimiting surface (5), wherein the direction is parallel to the reference plane of the upper delimiting surface (3).

As used throughout this patent application, the expression “or” is used in the inclusive sense instead of the exclusive sense, unless the exclusive sense is clearly defined in a specific situation. In this context, a sentence of the type “X uses A or B” must be interpreted as including all the pertinent inclusive combinations, for example “X uses A”, “X uses B” and “X uses A and B”.

As used throughout this patent application, the indefinite article “one” must be interpreted generally as “one or more”, unless the sense of a singular embodiment is clearly defined in a specific situation.

As presented in this specification, the expressions listed with examples must be interpreted with the purpose of illustrating an example and not indicating a preference.

The subject matter described above is provided as an illustration of the present invention and must not be interpreted so as to limit it. The terminology used with the purpose of describing specific embodiments, according to the present invention, must not be interpreted to limit the invention. As used in the specification, the definite and indefinite articles, in their singular form, aim at the interpretation of also including the plural forms, unless the context of the description indicates, explicitly, the contrary. It will be understood that the expressions “comprise” and “include”, when used in this description, specify the presence of the characteristics, the elements, the components, the steps, and the related operations, however, they do not exclude the possibility of other characteristics, elements, components, steps, and operations also being contemplated.

All the alterations, providing that they do not modify the essential characteristics of the claims that follow, must be considered as being within the scope of protection of the present invention.

### LIST OF REFERENCE INDICATIONS

1. A clamping device
2. An anterior delimiting surface
3. An upper delimiting surface
4. A rear delimiting surface
5. An inner delimiting surface
6. A trough
7. A protuberance
8. A first ridge
9. A flexible elastic element
10. A second ridge
11. A shaft
12. An orifice
13. An entrance to the stacking area of the sheets of paper
14. A first clamping device (14) according to the state of the art
15. A second clamping device (15) according to the state of the art

1. A clamping device (1) for a plurality of sheets of paper comprising:
an anterior delimiting surface (2); and
an upper delimiting surface (3); and
a rear delimiting surface (4); and
an inner delimiting surface (5); and
wherein the anterior delimiting surface (2), the rear delimiting surface (4) and the inner delimiting surface (5) are perpendicularly arranged relative to the upper delimiting surface (3); and
wherein the anterior delimiting surface (2), the inner delimiting surface (5) and an anterior portion of the upper delimiting surface (3) delimit a trough (6), which is configured for connecting with an upper edge of a support board of a plurality of sheets of paper; and
wherein the rear delimiting surface (4), the inner delimiting surface (5) and a rear portion of the upper delimiting surface (3) delimit a stacking area of the sheets of paper; and
wherein the inner delimiting surface (5) has a first ridge (8), which is arranged on a lower portion of said inner delimiting surface (5) and is projected towards the interior of the stacking area of the sheets of paper, characterized by
the rear delimiting surface (4) including a flexible elastic element (9) and a second ridge (10), which are arranged on an inner face of said rear delimiting surface (4) and are projected towards the interior of the stacking area of the sheets of paper, wherein said flexible elastic element (9) is arranged above said second ridge (10), as illustrated in FIG. 2; and
wherein the second ridge (10) includes an orifice (12), wherein there is fitted a shaft (11), wherein said shaft (11) presents a pivoting movement relative to the transverse axis of the second ridge (10), whereby said pivoting movement has an amplitude which is arranged within the stacking area of the sheets of paper and is limited by the contact of the shaft (11) with the first ridge (8) and by contact of the shaft (11) with the flexible elastic element (9).

2. The clamping device (1), according to claim 1, wherein the longitudinal length of the inner delimiting surface (5) is greater than the longitudinal length of the anterior delimiting surface (2) and wherein the first ridge (8) and the second ridge (10) are arranged on a same plane parallel to the plane of the upper delimiting surface (3).

3. The clamping device (1) according to claim 1, wherein at least one surface selected from the group consisting of the anterior delimiting surface (2) and the inner delimiting surface (5) includes at least one protuberance (7) transversely disposed.

4. The clamping device (1) according to claim 1, wherein the transverse length of a lower portion of the inner delimiting device (5) is smaller than the transverse length of an upper portion of the inner delimiting surface(5).

5. The clamping device (1) according to claim 1, wherein the flexible elastic element (9) is selected from the group consisting of a spring and a flap with a concave face projected toward the interior of the stacking area of the sheets of paper, wherein the base of the flap is connected to an upper portion of the rear delimiting surface (4) and the flexible terminal portion of the flap is arranged on a lower portion of the stacking area of the sheets of paper.

6. The clamping device (1) according to preceding claims claim 1, wherein the shaft (11) includes a support base orthogonally positioned relative to the shaft (11), wherein said support base is fitted under the second ridge (10) and the shaft ((11), pierces the orifice of the second ridge (10).
